(19) United States
(12) Patent Application Publication
(10) Pub. No.: US 2008/0245773 A1
(43) Pub. Date: Oct. 9, 2008

(54) Electrode Wire With Multi-Coated Layers For Electrical Discharge Machining and Method of Manufacturing the Same

(76) Inventor: Jong-Cho Lee, Anyang-Si (KR)

Correspondence Address: VOLENTINE & WHITT PLLC, ONE FREEDOM SQUARE, 11951 FREEDOM DRIVE SUITE 1260, RESTON, VA, 20190, US

(21) Appl. No.: 10/570,489

(22) PCT Filed: Feb. 2, 2005
(86) PCT No.: PCT/KR05/00302

§ 371 Date: Mar. 3, 2006

(30) Foreign Application Priority Data
Feb. 5, 2004 (KR) 10-2004-0007641

(51) Int. Cl. B23H 1/00

(52) U.S. Cl. 219/69.12

(57) ABSTRACT

An electrode wire with multi-coated layers for electrical discharge machining (EDM) is capable of fast and precisely machining a work piece for a desired shape without changing the electrode wire, and a method of manufacturing the electrode wire is obtained by performing the steps of manufacturing a core wire, coating the core wire with zinc, drying the coated core wire, diffusion-heat treating of the coated core wire, drawing a product from the coated core wire, and stabilization treating of the coated core wire in order.

### TECHNICAL FIELD

The present invention is related to an electrode wire for electrical discharge machining (EDM) which is capable of melting a work piece for a desired shape by electrical discharge, and more particularly, to an electrode wire with multi-coated layers for electrical discharge machining (EDM) for fast and precisely machining a work piece for a desired shape without changing the electrode wire, and a method of manufacturing the electrode wire using the steps of manufacturing a core wire, coating the core wire with zinc, drying the coated core wire, diffusion-heat treating of the coated core wire, drawing a product from the coated core wire, and stabilization treating of the coated core wire in order.

### BACKGROUND ART

In general, the electrical discharge machining (EDM) method is to melt a work piece and to cut the work piece for a desired shape as an electrode wire travels the work piece according to pre-programmed data from a computer, while a high voltage is applied between the electrode wire and the work piece. When applying the electric power, a discharge occurs between the electrode wire and the work piece.

In a prior art EDM apparatus adopting the EDM method, as shown in FIG. 1, an electrode wire 4 is inserted through a start hole 2 previously formed in a work piece 3 and then continuously fed through the start hole 2 according to a desired shape previously programmed in a computer (not shown). At the same time, the electric power, from a power supply 1 is applied between the electrode wire 4 and the work piece 3, thereby initiating a discharge therebetween and melting the work piece 3. Therefore the desired shape can be manufactured from the work piece 3.

According to materials of the coated electrode wire for the EDM, it is divided into brass (alloyed copper with zinc) electrode wire, zinc coated-brass electrode wire coated with zinc on the outer surface of the brass electrode wire, and zinc alloy (CuZn50 or CuZn65) coated electrode wire through heat treatment after zinc is coated on the surface of the brass electrode wire.

Now, the prior art coated electrode wires and the method of manufacturing the same are explained below:

First of all, U.S. Pat. No. 4,935,594 discloses a wire electrode for electro-erosive cutting of work pieces, as shown in FIG. 2, which includes a core 12, an electrolytic copper having more than 99.0% by weight of copper and a very low oxygen content or a copper-zinc-alloy having 79.5˜80.5% by weight of copper, and a coating layer 14 made from metal (for example, zinc, cadmium, bismuth or antimony) having a low volatilization energy characteristic, or an alloy of such metal. Also it discloses the method of manufacturing the wire electrode.

U.S. Pat. No. 4,287,404 discloses an electrode for machining work pieces using electrical discharge, which includes a core made of material having a relatively high mechanical strength and a relatively thin metallic surface coating thereon. Here, the relatively thin metallic surface coating includes at least 50% by weight of metal having a low vaporization temperature, which is selected from the group consisting of zinc, cadmium, tin, lead, antimony, bismuth and an alloy thereof.

U.S. Pat. No. 4,998,552 discloses a wire electrode for a traveling wire EDM method, as shown in FIG. 3, which includes a core 12 made of steel, a lower layer 16 made of homogeneous copper (Cu of 100%) and an upper brass layer 18 including zinc of 10˜50% by weight. Here the core made of steel is surrounded by copper or copper alloy to form a multi-layer structure, thereby having a relatively large mechanical strength.

Korean Patent Application No. 10-1985-0009194 discloses a wire electrode for an EDM method, which includes a steel core coated with copper or other components, and copper-zinc alloy layer of CuZn10˜CuZn50 coated on the steel core. The wire electrode machines a work piece as the same manner mentioned above.

U.S. Pat. No. 4,968,867 discloses a wire electrode for wire cut electric discharge machining, which includes a core wire having relatively high thermal conductivity, a lower coating layer formed by a low-boiling point material (for example, zinc) and an outermost layer of brass having high mechanical strength. Here, the core wire is made of copper, silver, aluminum or alloys thereby.

U.S. Pat. No. 5,945,010 discloses a coated EDM wire electrode, which includes a core wire and an outer coating layer made of copper-zinc alloy of CuZn65, instead of copper-zinc alloy of CuZn10 to CuZn50. But, since the copper-zinc alloy of CuZn65 includes phase, as shown in FIG. 4, the outer coating layer is peeled off or generates a gap. Namely, as the outer coating layer of phase is broken up during cold drawings, it may form a discontinuous or broken-up coating on the wire core that does not completely cover the surface of the wire core.

U.S. Pat. No. 6,306,523 discloses a method of manufacturing porous electrode wire for EDM and the electrode wire using the method. As shown in FIG. 5, the porous electrode wire includes a core wire made of copper, an alloy layer formed on the core wire, and a coating layer made of zinc, which has cracks for adding a cooling effect thereto.

Each of the embodiments according to the prior art has a single coating layer on the core wire capable of showing only a single function, instead they do not include composite coating layers for multi-functions. Therefore the prior art EDM apparatus must change an electrode wire into the other one depending on the kinds of works such as rough cut and finish cut. For example, for machining a work piece accurately and fast, the prior art EDM apparatus must use an electrode wire for precision machining and then adopt another electrode wire for high speed. Therefore the prior art EDM apparatus has disadvantages in that it must change the electrodes wires depending on the kinds of works, thereby elongating the machining time.

Also, since the electrode wires for EDM disclosed in U.S. Pat. Nos. 5,945,010 and 6,306,523 have un-uniform cracks on the coating layer, the electrical discharges occur un-uniformly, thereby the machining surface of the work piece cannot be machined even.

### DISCLOSURE OF INVENTION

### Technical Problem

The object of the present invention is to provide an electrode wire with multi-coated layers for electrical discharge machining, which has at least two coated layers including an outer layer made of zinc for precision machining and an lower layer made of zinc alloy for fast machining, thereby machining a work piece continuously without change thereof.

The another object of the present invention is to a method of manufacturing an electrode wire with multi-coated layers for electrical discharge machining, which includes steps of manufacturing a core wire, coating the core wire, drying the coated core wire, diffusion-heat treating of the coated core wire, drawing the coated core wire for product, and stabilization treating the coated core wire in order, in which the electrode wire has at least two coated layers including an outer layer made of zinc for precision machining the work piece and an lower layer made of zinc alloy for fast machining the work piece, thereby machining the work piece continuously without change thereof.

### Technical Solution

The above-mentioned objects are achieved by a method of manufacturing an electrode wire with multi-coated layers for electrical discharge machining, comprising: manufacturing a core wire as material having a diameter of 2.5 mm is drawn to 0.9 to 1.0 mm; coating pure zinc on an outer surface of the core wire with a thickness from 5 to 10 m; drying the coated wire to get rid of moisture therefrom, including: raising a temperature from a room temperature to 50˜60 C by 1 to 2 C per a minute in a diffusion-heat treating furnace; and maintaining the coated wire at the temperature of 50˜60 C for 60 to 120 minutes; diffusion-heat treating the coated wire, thereby forming multi-coated layers on the coated wire, including: raising the temperature from 50˜60 C to 120˜180 C by 2 to 3 C per a minute; maintaining the coated wire at the temperature of 120˜180 C for 50˜90 minutes; cooling the coated wire by decreasing the temperature from 120˜180 C to 50˜60 C by 2 to 3 C per a minute; drawing the coated wire with the multi-coated layers as a finished product to a diameter of 0.1˜0.33 mm; and stabilization treating the multi-coated wire, including: heating the multi-coated wire to a temperature of 200˜220 C in an air atmosphere; and cooling the heated multi-coated wire at the air atmosphere.

Preferably, the electrode wire with multicoated layers for electrical discharge machining (EDM) manufactured by the method above comprising: a core wire; a zinc alloy layer formed on the core wire; and a zinc layer on the alloy zinc layer.

### ADVANTAGEOUS EFFECTS

According to the embodiments of the present invention, the electrode wire with the coated layers is manufactured by the method that a core wire manufacturing step, which is made of copper or alloyed copper, coating step for coating the core wire with zinc, drying step for drying the coated core wire, diffusion-heat treating step for the coated core wire, a product drawing step for the coated core wire after going through the diffusion-heat treatment, and stabilization treating step are performed in order. The electrode wire has a structure forming a core wire, a zinc alloy layer as an inner layer suitable for fast machining and a zinc layer as an outer layer for precision machining. Therefore, the electrode wire of the present invention can fast and accurately machine a work piece without change thereof.

Also the electrode wire can be manufactured at a relatively low cost. Also, when discharging for machining a work piece, any debris is not separated from the core wire, thereby the machining work is not interrupted by the electrode wire.

Also, the electrode wire can be manufactured in the air atmosphere not using an inert gas, therefore the cost can be reduced.

### BRIEF DESCRIPTION OF THE DRAWINGS

FIG. 1 is a perspective view illustrating an electrical discharge machining (EDM) apparatus for explaining EDM method of machining a work piece in accordance with the prior art;

FIGS. 2 and 3 are cross-sectional views illustrating the prior art coated electrode wires;

FIGS. 4 and 5 are photographs illustrating the surface of the prior art coated electrode wire;

FIG. 6 is a cross-sectional view illustrating the electrode wire with multi-coated layers in accordance with the present invention;

FIG. 7 is a photograph illustrating the surface of the electrode wire with multi-coated layers in accordance with the present invention; and

FIG. 8 is a flow chart illustrating the method of manufacturing the electrode wire with the multi-coated layers in accordance with the present invention.

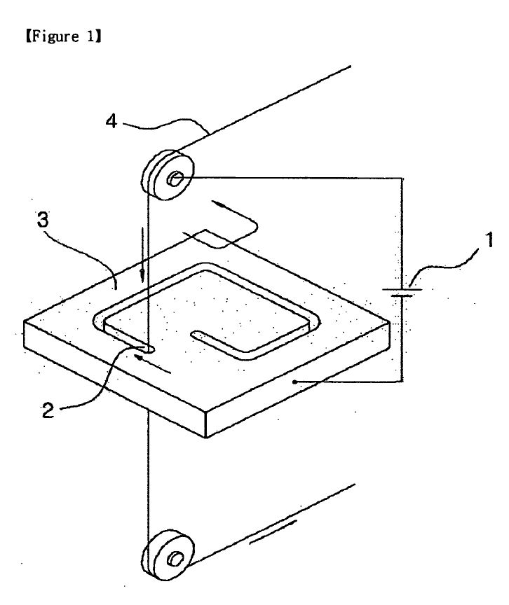

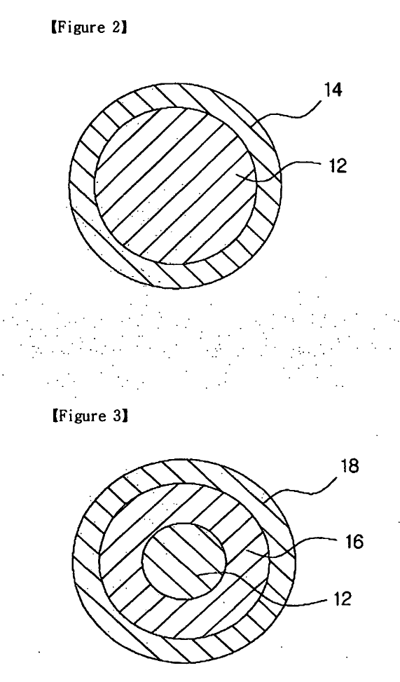

### BEST MODE FOR CARRYING OUT THE INVENTION

Referring to the drawings, the embodiments of the present invention will be explained in detailed as below.

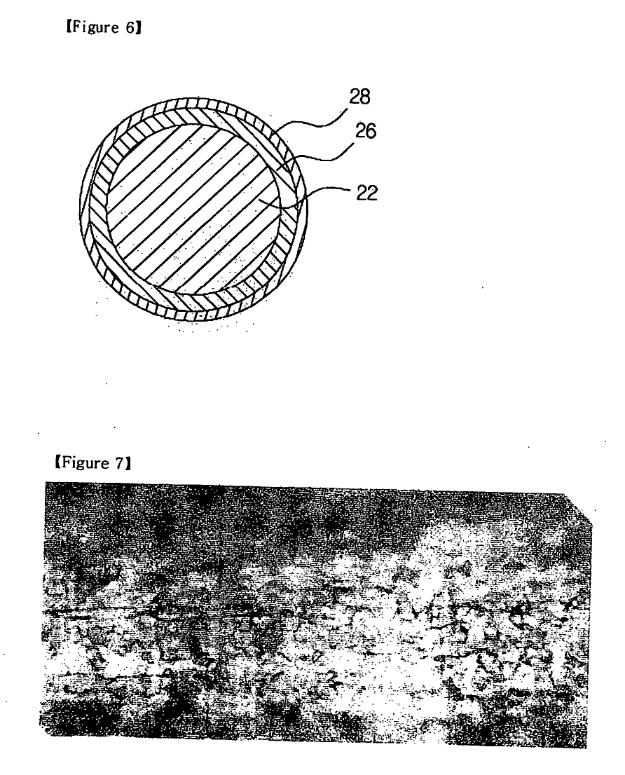

The electrode wire with multi-coated layers in accordance with the present invention, as shown in FIG. 6, includes a core wire 22 made of copper or brass (which is alloyed copper with zinc), a lower layer 26 made of zinc alloy (CuZn80˜CuZn95) formed on the core wire 22, and a upper layer 28 made of zinc (CuZn90˜CuZn100) formed on the lower layer 26.

Here, the lower layer 26 has functions for fast and accurate machining a work piece. The zinc alloy has characteristics of relatively higher sublimation point, on the other hand the zinc has characteristics of relatively lower sublimation point.

More specifically, the function of zinc having a relatively lower sublimation point and the availability of the electrode wire of the present invention will be explained as follows.

First of all, the machining speed of the electrical discharge machining (EDM) apparatus using the electrode wire is faster according as the amount of discharge between the electrode wire and the work piece is increased. Here, the amount of discharge is determined by the magnitude of electric power between the electrode wire and the work piece.

However, when occurring a discharge between the electrode wire and the work piece, a relatively large amount of heat is generated therebetween, thereby the work piece is melted to cut. Simultaneously, the surface of the electrode wire is suffered the same action as the work piece, thereby the electrode wire is also melted to broke due to the heat. To prevent the electrode wire from breaking, cooling water with a high pressure is supplied to the discharging surface between the electrode wire and the work piece when the EDM apparatus is operating.

Therefore, the maximum magnitude of electric power supplied to the electrode wire is preferably within a predetermined range such that the electrode is not damaged.

Meanwhile, if the electrode wire is not damaged at a relatively higher electric power, it can cut the work piece with a relatively higher speed.

In general, if the temperature of the electrode wire is increased due to the heat by the discharge, the electrode wire is easily cut. To prevent the electrode wire from cutting, zinc having a cooling function is coated on the surface of the electrode wire. Namely, when discharging, zinc coated on the electrode wire functions to reduce the temperature of the electrode wire by its sublimation heat which is generated at the sublimation point of 906 C, which is called as a cooling action. Therefore, since zinc can prevent the temperature of the electrode wire from increasing, zinc makes the electrode wire accept a relatively higher electric power.

However, even though zinc is useful as a cooling metal, it has a disadvantage as follows.

When discharge occurs between the electrode wire and the work piece, the surface of the electrode wire is melted and peeled off like the work piece. Here, since pure zinc is easily sublimated during the electrical discharge machining, if the electric power is increased to machine the work piece relatively thick or to increase its machining speed, zinc is sublimated from the surface of the electrode wire. Therefore, the electrode wire is formed like its diameter is gradually decreased in the longitudinal direction from its both sides as the center thereof is approached such that it machines the work piece to slope like the surface shape thereof.

Therefore, the electrode wire coated with pure zinc is limited to use only for precision machining within a predetermined electric power.

The zinc coated electrode wire is useful for precision machining and the zinc alloy coated electrode wire is useful for fast machining the work piece or for accurately machining the work piece relatively thick.

In general, the electric discharge machining performs (1) a rough cut and then (2) a finish cut. The step of the rough cut takes much time to machine the work piece, while the finish cut fast machines the work piece such that it takes less time than the rough cut does.

Therefore, based on the kind of coated electrode wire, an applied electric power and a electric discharge machining, the coated electrode wire can be briefly summarized as follows: when the work piece is machined by the rough cut and the final cut, each of which must use for its own suitable electrode wire. Namely since the feature of the electrode wire for the rough cut is different from that for the final cut, the final cut after the rough cut requires to change the electrode wire for the rough cut into the electrode wire for final cut, and vice versa. However, even if the electrode wire should be changed according to the machining steps, substantially they are not needed to change. Namely, when accurately machining a work piece, an electrode wire for precise machining is used controlling the machining speed. Also, when fast machining the work piece, an electrode wire for fast machining is used.

For this, the electrode wire with multi-coated layers in accordance with the present invention, as shown in FIG. 6, is implemented by two layers, each of which is a upper layer 28 made of zinc (which has a lower sublimation point) for precise machining and a lower layer 26 made of zinc alloy (which has a higher sublimation point) for fast machining. Therefore the electrode wire of the present invention can fast and accurately machine the work piece without changing itself into the other.

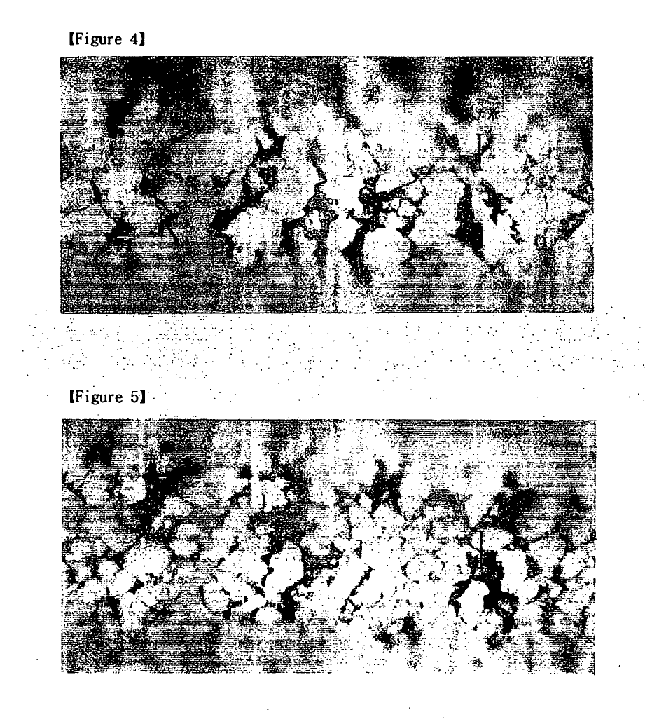

Meanwhile, to provide a cooling effect, the prior art electrode wire, as shown in FIG. 5, forms cracks on the surface thereof. On the other hand, since the electrode wire of the present invention, as shown in FIG. 7, is cooled without forming the cracks on its surface, it discharges uniformly. Especially, the electrode wire of the present invention shows more large cooling effect due to pure zinc of the upper layer 28.

Now, referring to the drawings, the method of manufacturing the electrode wire with multi-coated layers will be explained as follows.

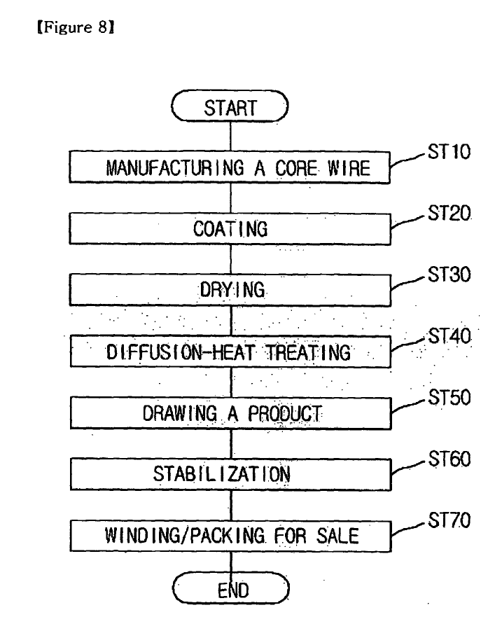

FIG. 8 is a flow chart illustrating the method of manufacturing the electrode wire with the multi-coated layers in accordance with the present invention, which includes a upper layer 28 made of zinc (which has a lower sublimation point) for accurate machining and a lower layer 26 made of zinc alloy (which has a higher sublimation point) for fast machining. Therefore the electrode wire of the present invention can fast and accurately machine the work piece without changing itself into the other.

As shown in the drawing, the method for manufacturing the electrode wire with the coated layers comprises core wire manufacturing step ST10, coating step ST20, drying step ST30, diffusion-heat treating step ST40, a product drawing step ST50, stabilization treating step ST60, and winding/packing step ST70 for a product.

### MODE FOR THE INVENTION

Each step will be explained in detail below.

(1) Core wire manufacturing step

Using a fine particle typed artificial diamond drawing dies, a core wire is manufactured as material is drawn to its diameter from 2.5 mm to 0.9˜1 mm. Here, the core wire has circularity of 1 m. Also its surface is even without scratches. After that, the core wire is proceeded by annealing heat-treatment so that its tensile strength is less than ½ hard.

(2) Coating step

Using electro-plating method or melting coating method, pure zinc is coated on the surface of the core wire such that the coating thickness is from 5 to 10 m. Here, to diffuse well in a suitable temperature diffusion-heat treatment step, the size of the coating particles is preferably less than 2 m. Therefore the coating surface can be even.

(3) Drying step

After that, the coated wire is dried in an air atmosphere (not at an inert gas atmosphere) of a diffusion heat-treating furnace which is heated to increase its temperature by 1˜2 C per minute from a room temperature until 50˜60 C and then maintained at 50˜60 C for 60˜120 minutes.

(4) Diffusion-heat treating step

After that, the coated wire is heated in the same diffusion heat-treating furnace of the drying step, which is heated to increase its temperature by 1˜3 C per minute from the temperature of 50˜60 C until 120˜180 C, and then maintained at 120˜180 C for 50˜90 minutes. After that, the diffusion heat-treating furnace is cooled decreasing its temperature by 2˜3 C per minute from 120˜180 C until 50˜60 C. When reaching 50˜60 C, the coated wire is taken out from the diffusion heat-treating furnace and then cooled in the air.

Through the above steps, the coated zinc 28 coated on the core wire 22, as shown in FIG. 6, forms a new zinc alloy layer 26 as a lower layer at the interface surface between the core wire and the coated zinc. Namely, the coated core wire has two layers which are zinc layer 28 and zinc alloy layer 26. Here the thickness of the new zinc alloy layer is determined by the diffusion-heat treatment. For example, if the core wire is coated with pure zinc by 10 m and then proceeded by the diffusion-heat treatment, 5 m from the outer surface thereof is remains pure zinc (CuZn90˜CuZn100) as an upper layer and the other portion, 5 m, between the upper layer and the outer surface of the core wire is changed into an zinc alloy layer of CuZn80˜CuZn95.

(5) Product drawing step

After diffusion-heat treating, the coated wire with two layers is drawn to the diameter of 0.10.33 mm, as a finished product, using a drawing dies.

While drawing, the coated zinc on the core wire is strongly rubbed with the inner surface of the drawing dies. Since pure zinc of the outer surface does not have toughness and malleability, a drawing dies must be made of fine particle type artificial diamond and has a reduction angle of 12˜15.

For example, if the coated core wire with a pure zinc layer and a zinc alloy layer is drawn to its diameter by 0.25 mm, then the thickness of the zinc layer becomes 1.5 m. On the other hand, since the zinc alloy layer is material (not to be drawn), its thickness can hardly be changed. Instead the organization of the zinc alloy is cracked such that the zinc alloy is fixedly lodged on the core wire.

Therefore, if the thickness ratio of upper layer to lower layer before drawing is 50:50, it is changed into 20:80˜30:70 after drawing. For example, if a core wire having a diameter of 0.9 mm coated with a zinc layer of 5 m thick and an zinc alloy layer of 5 m thick is drawn to 0.25 mm, the zinc layer and the zinc alloy layer are changed to 1.5 m and 5 m, respectively.

(6) Stabilization treating step

Since the core wire after going through the product drawing step, which is called as a cold working, has a metallically internal stress, therefore its electrical conductivity is decreased. Also, its mechanical strength becomes un-uniform.

The core wire having such problems can be removed by a stabilization treatment. Namely the stabilization treatment can get rid of the internal stress of the core wire and enhance the mechanical and electrical characteristics thereof. More specifically, the stabilization treatment performs like the zinc alloy is heated to 180˜200 C in the atmosphere without oxygen and then cooled by water, and copper of core wire is heated to 200˜220 C in the air atmosphere and then cooled in the same situation.

Therefore the electrode wire of the present invention can be manufactured as zinc alloy layer is formed on the core and zinc layer is formed on the zinc alloy layer.

(7) Winding/packing step for sale

After performing the stabilization treatment, the electrode wire with multi-coated layers is wounded on a roller and packed for sale as a prior art method.

### INDUSTRIAL APPLICABILITY

Having disclosed the best embodiment of the present invention, however, many modifications thereto will become apparent to those skilled in the art to which it pertains, without deviation from the spirit of the invention, as defined by the scope of the appended claims.

1. A method of manufacturing an electrode wire with multi-coated layers for electrical discharge machining (EDM), comprising:
manufacturing a core wire as material having a diameter of 2.5 mm is drawn to 0.9 to 1.0 mm;
coating pure zinc on an outer surface of the core wire with a thickness from 5 to 10 m;
drying the coated wire to get rid of moisture therefrom, including:
raising a temperature from a room temperature to 50˜60 C by 1 to 2 C per a minute in a diffusion-heat treating furnace; and
maintaining the coated wire at the temperature of 50˜60 C for 60 to 120 minutes;
diffusion-heat treating the coated wire, thereby forming multi-coated layers on the coated wire, including:
raising the temperature from 50˜60 C to 120˜180 C by 2 to 3 C per a minute;
maintaining the coated wire at the temperature of 120˜180 C for 50˜90 minutes;
cooling the coated wire by decreasing the temperature from 120˜180 C to 50˜60 C by 2 to 3 C per a minute;
drawing the coated wire with the multi-coated layers as a finished product to a diameter of 0.1˜0.33 mm; and
stabilization treating the multi-coated wire, including:
heating the multi-coated wire to a temperature of 200˜220 C in an air atmosphere; and
cooling the heated multi-coated wire at the air atmosphere.

2. The method according to claim 1, wherein the step of manufacturing the core wire including:
drawing so that a circularity of the core wire is more than 1 m; and
annealing heat-treatment so that a tensile strength of the core wire is less than ½ hard.

3. The method according to claim 1, wherein the step of coating pure zinc is to use a particle of which size is less than 2 m.

4. The method according to claim 1, wherein the diffusion-heat treating step is to form a pure zinc layer of CuZn90˜CuZn100, which is 5 m from an outer surface, and an zinc alloy layer of CuZn80-CuZn95 between the pure layer and the outer surface of the core wire, which is 5 m.

5. The method according to claim 1, wherein the drawing step is use a drawing dies made of material which is fine particle type artificial diamond and has a press angle of 12˜15.

6. The method according to claim 1, wherein the multi-coated layers is a lower layer formed on the surface of the core wire and an upper layer on the lower layer, wherein a thickness ratio of the upper layer to the lower layer is 20:80˜30:70.

7. An electrode wire with multicoated layers for electrical discharge machining (EDM) manufactured by the method according to claim 1, the electrode wire comprising:
a core wire;
a zinc alloy layer formed on the core wire; and
a zinc layer on the alloy zinc layer.
